(19) United States
(12) Patent Application Publication
(10) Pub. No.: US 2012/0115009 A1
(43) Pub. Date: May 10, 2012

(54) SHRINK RESISTANT MICROPOROUS MEMBRANE AND BATTERY SEPARATOR

(75) Inventors: Moriaki Okuno, Kanagawa (JP); Toshitsugu Ono, Miyagi (JP)

(73) Assignee: SONY CORPORATION, Tokyo (JP)

(21) Appl. No.: 13/271,786

(22) Filed: Oct. 12, 2011

(30) Foreign Application Priority Data
Nov. 8, 2010 (JP) 2010-250211

(51) Int. Cl. H01M 2/16; B32B 3/26

(52) U.S. Cl. 429/145; 428/319.1; 428/318.4

(57) ABSTRACT

A shrink resistant microporous membrane includes a base material composed of a porous membrane, and a surface layer that is formed on at least one surface of the base material, and contains a heat resistant resin, a ceramic, and a clay mineral.

### CROSS REFERENCES TO RELATED APPLICATIONS

The present application claims priority to Japanese Patent Application No. 2010-250211 filed on Nov. 8, 2010, the disclosure of which is incorporated herein by reference.

### BACKGROUND

The present disclosure relates to a shrink resistant microporous membrane having a heat resistant insulating layer formed therein, and, more specifically, to a shrink resistant microporous membrane provided with a base material composed of a polyolefin resin or the like, and a surface layer containing inorganic particles and a clay mineral in a heat resistant resin, and a battery separator.

In recent years, as portable information electronic devices, such as cellular phones, video cameras, and notebook-type personal computers, have become widespread, achieving performance enhancements, miniaturization, and weight reduction of these devices have been attempted. Primary batteries that are disposed of after use and secondary batteries that can be used repeatedly are used as a power supply for these devices, but secondary batteries, particularly, lithium ion secondary batteries, are in increasing demand due to their favorable comprehensive balance of performance enhancement, miniaturization, weight reduction, economic efficiency, and the like. Additional performance enhancement, miniaturization, and the like are underway for these devices, and there is demand for an increase in energy density with regard to lithium ion secondary batteries.

Since the energy density of lithium ion secondary batteries has increased along with the capacity, there is a significantly increasing demand for reliability improvement in preparation for a discharge of a large energy in the case of battery overheating or internal short-circuit. Therefore, there is strong demand for a lithium ion secondary battery that can satisfy both high reliability and an increase in capacity with respect to such tests.

An ordinary lithium ion secondary battery is provided with a positive electrode including a lithium complex oxide, a negative electrode including a material that can absorb and discharge lithium ions, a separator interposed between the positive electrode and the negative electrode, and a non-aqueous electrolytic solution. In addition, the positive electrode and the negative electrode are laminated with the separator interposed therebetween, or the positive electrode and the negative electrode are laminated and then wound so as to configure a cylindrical wound electrode. The separator plays a role of electrically insulating the positive electrode and the negative electrode and a role of holding the non-aqueous electrolytic solution. A polyolefin microporous membrane is usually used as the separator of the lithium ion secondary battery.

A polyolefin microporous membrane is widely used as a separator of the lithium ion secondary battery, a condenser, and the like due to its excellent electrical insulating properties and ion permeability. Since a lithium ion secondary battery has a high output density and a high capacity density, but includes an organic solvent as the electrolytic solution, there are cases in which the electrolytic solution is decomposed by heat generated by abnormal situations, such as a short-circuit and over-charging, and ignition is brought about in the worst case. Several safety functions are incorporated in a lithium ion secondary battery to prevent such situations, and a shutdown function of a separator is one of those functions.

The shutdown function of a separator refers to a function by which micro-pores in the separator are blocked by thermal fusion and the like when an abnormal situation happens in a battery so that ion conduction in the electrolytic solution is suppressed, and an electrochemical reaction is stopped. Generally, stability is enhanced as the shutdown temperature lowers, and one of the reasons why polyethylene is used as a component of the separator is that polyethylene has an appropriate shutdown temperature. However, in a battery having a high energy, there is a problem in that the temperature in the battery continuously increases even when the electrochemical reaction is stopped by shutdown, and, consequently, the separator is thermally shrunk and broken such that the both electrodes are short-circuited.

In order to solve the above problem, Japanese Patent No. 3756815 suggests a method in which a heat resistant surface layer containing a heat resistant material having a softening temperature of 120° C. or higher, such as organic fine particles, inorganic fine particles, organic fibers, and inorganic fibers, is formed between the separator and the electrode. According to this method, the short-circuit between both electrodes can be prevented even when the temperature is continuously increased beyond the shutdown temperature such that the separator is broken since the surface layer including the fine particles and fibers is present as an insulating layer.

In addition, Japanese Unexamined Patent Application Publication No. 2004-9012 suggests a separator containing a highly heat resistant resin material having an improved strength. In Japanese Unexamined Patent Application Publication No. 2004-9012, the separator is made by mixing denatured lamellar silicate with polyvinylidene fluoride, which is a heat resistant resin.

### SUMMARY

The amount of heat generated by abnormal heat generation is large in a high capacity battery, and, in a separator having a surface layer containing a heat resistant material formed on the surface, there is a problem in that the separator is broken such that the surface layer may be lost once abnormal heat generation occurs. In addition, there is another problem in that the separator is thermally shrunk together with the surface layer such that both electrodes may be short-circuited during abnormal heat generation.

The problem of the short-circuit during abnormal heat generation can be solved by using polyolefin having a high melting point as a material for the microporous membrane so as to improve the heat resistance of the microporous membrane. However, there is demand for a separator to have the so-called shutdown function, by which the membrane is thermally fused at the shutdown temperature so that pores are blocked. When polyolefin having a high melting point is used as a material for the microporous membrane that is used for a separator as described in Japanese Patent No. 3756815, the shutdown temperature becomes too high, or shutdown does not occur, and therefore it may not be possible to maintain the safety of a battery.

The short-circuit problem can be solved by using a polyolefin microporous membrane having the shutdown function as a base material and increasing the thickness of the heat resistant surface layer laminated on the polyolefin microporous membrane. However, when the thickness of the surface layer is increased, the volume occupied by the separator in a battery is increased, which is not advantageous from the viewpoint of an increase in the capacity of the battery. In addition, when the thickness of the surface layer is increased, there is a tendency for air permeability to increase. When the air permeability is increased, battery performances are degraded, which is not preferable.

In addition, the strength of polyvinylidene fluoride can be improved by mixing denatured lamellar silicate in the separator of Japanese Unexamined Patent Application Publication No. 2004-9012, but it is hard to say that the obtained strength can be the same as that of polyolefin.

The present disclosure has been made in consideration of the problems in the above related art, and it is desirable to provide a shrink resistant microporous membrane that suppresses thermal shrinkage without increasing the thickness of the surface layer and a battery separator.

In order to solve the above problems, the shrink resistant microporous membrane and the battery separator of an embodiment of the present disclosure are composed of a base material composed of a porous membrane, and a surface layer that is formed on at least one surface of the base material and contains a heat resistant resin, a ceramic, and a clay mineral.

In the shrink resistant microporous membrane of an embodiment of the present disclosure, a clay mineral having a lamellar structure in which a number of layers are laminated on the surface layer is dispersed. Thereby, the strength and softening point of the heat resistant resin in the surface layer are improved, and the adhesiveness between the ceramic in the surface layer and the resin composing the base material can be increased.

According to the embodiment of the present disclosure, addition of a clay mineral to the microporous membrane having the base material and the surface layer laminated improves the mechanical characteristics and heat resistance of the surface layer and increases the adhesiveness between the surface layer and the base material so that the base material is not easily shrunk. Therefore, it is possible to degrade shrink properties across the microporous membrane while the base material maintains the shutdown function.

Additional features and advantages are described herein, and will be apparent from the following Detailed Description and the figures.

### BRIEF DESCRIPTION OF THE FIGURES

FIG. 1 is a cross-sectional view showing a configuration example of the shrink resistant microporous membrane according to an embodiment of the present disclosure.

FIG. 2 is a schematic view showing the shape of a clay mineral whose surface is modified by a heat resistant resin and an organic modifier in the surface layer of the shrink resistant microporous membrane according to an embodiment of the present disclosure.

FIG. 3 is a TEM image of the surface of a microporous resin membrane to which denatured lamellar silicate is added.

FIG. 4A and FIG. 4B are TEM images of the surface of a microporous resin membrane to which denatured lamellar silicate is added.

FIG. 5A and FIG. 5B are TEM images of the surface of a microporous resin membrane to which denatured lamellar silicate is added.

FIG. 6A is a schematic view showing the dispersion state of a layer separation-type clay mineral in the surface layer of the shrink resistant microporous membrane of an embodiment of the present disclosure, and FIG. 6B is a graph of the evaluation results of a clay mineral by the X-ray diffraction method.

FIG. 7A is a schematic view showing the dispersion state of an interlayer insertion-type clay mineral in the surface layer of the shrink resistant microporous membrane of an embodiment of the present disclosure, and FIG. 7B is a graph of the evaluation results of a clay mineral by the X-ray diffraction method.

FIG. 8 is a graph showing the measurement results by a thermal mechanical analyzer of a resin membrane in which a clay mineral is dispersed.

### DETAILED DESCRIPTION

Embodiments of the present application will be described below in detail with reference to the drawings.

1. A first embodiment (an example of the shrink resistant microporous membrane according to an embodiment of the present disclosure)

2. Other embodiments

### 1. First Embodiment

The shrink resistant microporous membrane according to a first embodiment has a surface layer, to which a nano-order-sized clay mineral is added together with a heat resistant resin and an inorganic material, formed on at least one surface of a base material layer. The shrink resistant microporous membrane can be used not only for use in battery separators but also for use in ordinary heat resistant resin films. Hereinafter, the shrink resistant microporous membrane according to an embodiment of the present disclosure will be described in detail.

(1-1) Structure of the Shrink Resistant Microporous Membrane

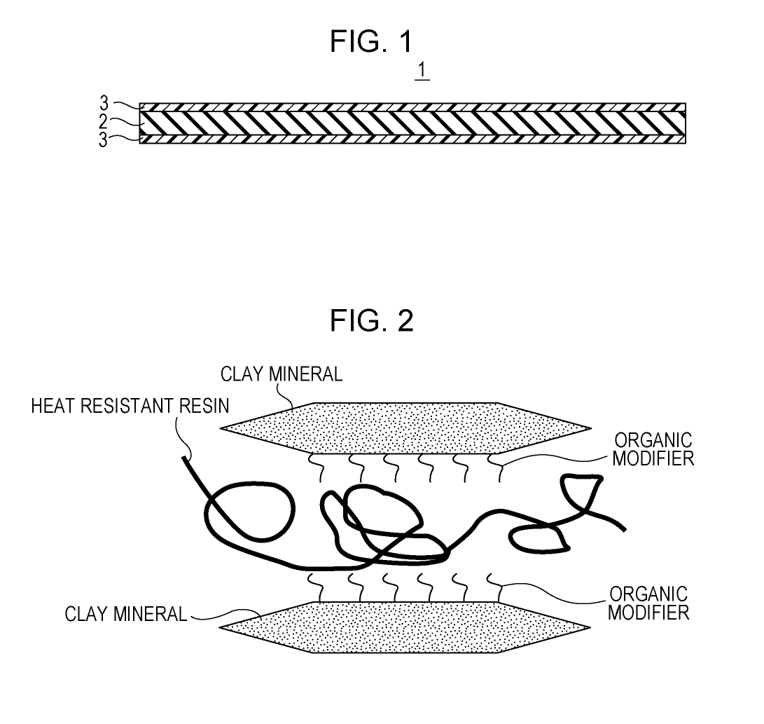

The shrink resistant microporous membrane according to the first embodiment is provided with a base material layer 2 composed of a microporous membrane that is excellent in terms of strength and a surface layer 3 that is formed on at least one surface of the base material layer 2 and is excellent in terms of heat resistance and shrink resistance as shown in FIG. 1. When the shrink resistant microporous membrane 1 is used for use in a battery, that is, as a separator, the shrink resistant microporous membrane 1 separates the positive electrode and the negative electrode, prevents the short-circuit of electric current by the contact of both electrodes, and allows lithium ions to pass. Meanwhile, hereinafter, a case in which the shrink resistant microporous membrane 1 is used as a separator will be described, but the use of the shrink resistant microporous membrane 1 is not limited to a separator.

[Base Material Layer]

The base material layer 2 is a porous resin membrane composed of a thin insulating film having large ion permeability and a predetermined mechanical strength. Examples of such resin materials that are preferably used include polyolefin-based synthetic resins, such as polypropylene and polyethylene, acrylic resins, styrene resins, polyester resins, nylon resins, and the like. Particularly, polyethylene, such as low-density polyethylene, high-density polyethylene, and linear polyethylene, and low-molecular-weight wax fractions thereof, or polyolefin resins, such as polypropylene, can be preferably used since they have an appropriate melting point and are easily obtainable. In addition, the porous membrane may be a porous membrane having a structure in which two or more porous membranes are laminated or formed by melting and kneading two or more resin materials. Porous membranes including a polyolefin-based porous membrane have excellent properties that separate the positive electrode and the negative electrode so that the porous membranes can further reduce internal short-circuiting or degradation of an open-circuit voltage.

The thickness of the base material 2 may be arbitrarily set as long as the thickness is thick enough to maintain the necessary strength. When the heat resistant microporous membrane 1 is used as a battery separator, the base material 2 is preferably set to a thickness that achieves insulation between the positive electrode and the negative electrode, prevents short-circuit and the like, has ion permeability for preferably carrying out a battery reaction through the heat resistant microporous membrane 1, and can increase as much as possible the volume efficiency of an active material layer that contributes to the battery reaction in the battery. Specifically, the thickness of the base material 2 is preferably 12 μm to 20 μm. In addition, the porosity in the base material 2 is preferably 40% to 50% in order to obtain the ion permeability.

[Surface Layer]

The surface layer 3 is formed on at least one surface of the base material layer 2, and contains an inorganic material, such as a heat resistant resin and ceramic particles (hereinafter referred to appropriately as “ceramics”), and a clay mineral. The shrink resistant microporous membrane 1 is disposed so that the surface layer 3 faces at least the positive electrode, that is, the surface layer 3 is located between the positive electrode and the base material layer 2 when disposed in a battery.

The kind of the heat resistant resin is not limited as long as the heat resistant resin has a desired heat resistance for use in an ordinary resin film. The surface layer is provided for the purpose of protecting the base material composed of a resin material having a mechanical strength, and has a higher melting point than that of a resin material composing the base material layer 2. On the other hand, when the shrink resistant microporous membrane of an embodiment of the present disclosure is used as a battery separator, it is preferable to use a resin material that is insoluble in a non-aqueous electrolytic solution in a battery and is electrochemically stable in the operating range of the battery.

Examples of the heat resistant resins include polyolefin materials, such as polyethylene and polypropylene, fluorine-containing resins, such as polyvinylidene fluoride and polytetrafluoroethylene, fluorine-containing rubbers, such as vinylidene fluoride-hexafluoropropylene-tetrafluoro ethylene copolymers, vinylidene-tetrafluoroethylene copolymers, and ethylene-tetrafluoroethylene copolymers, styrene-butadiene copolymers and hydrides thereof, acrylonitrile-butadiene copolymers and hydrides thereof, acrylonitrile-butadiene-styrene copolymers and hydrides thereof, rubbers, such as methacrylate-acrylate ester copolymers, styrene-acrylic acid ester copolymers, acrylonitrile-acrylic acid ester copolymers, ethylene propylene rubber, polyvinyl alcohol, and polyvinyl acetate, cellulose derivatives, such as ethyl cellulose, methyl cellulose, hydroxyethyl cellulose, and carboxyethyl cellulose, resins having at least one of the melting point and the glass transition temperature of 180° C. or higher, such as polyphenyl ether, polysulfone, polyether sulfone, polyphenylene sulfide, polyether imide, polyamide imide, polyamide, and polyester.

Among the above, it is preferable to use polyvinylidene fluoride as the heat resistant resin, and it is more preferable to have a functional group in the structure of the heat resistant resin. Thereby, the clay mineral can be dispersed more evenly with respect to a fluorine-based polymer, and therefore the thermal shrinkage suppression effect can be obtained more reliably. In addition, the heat resistant resin can be sufficiently adhered to the ceramics, and, when a polar group is present in the organic modifier of the clay mineral, the presence of the interaction between the polar groups can further improve the properties. Meanwhile, the fluorine-based polymer having a functional group refers to functional group-containing fluorine-based polymers in which the functional group is introduced by variation or copolymerization during the manufacture, and the like. Examples of the commercially available products of the functional group-containing fluorine-based polymers that can be used include KF POLYMER (registered trade mark) W#9300, W#9200, W#9100, and the like, which are manufactured by Kureha Corporation.

[Ceramics]

Examples of the ceramics include electrically insulating metallic oxides, metallic nitrides, metallic carbides, and the like. Examples of the metallic oxides that can be preferably used include alumina (Al₂O₃), magnesia (MgO), titania (TiO₂), zircona (ZrO₂), silica (SiO₂), and the like. Examples of the metallic nitrides that can be preferably used include silicon nitride (Si₃N₄), aluminum nitride (AlN), boron nitride (BN), titanium nitride (TiN), and the like. Examples of the metallic carbides that can be preferably used include silicon carbide (SiC), boron carbide (B₄C), and the like.

In addition, ceramics that are used are preferably basic ceramics. Thereby, the polar group of the clay mineral is coordinated at the surface basic sites in the ceramics so that the adhesiveness between the ceramics and the clay mineral is improved as described below.

Particles of the ceramics may be used singly or as a mixture of two or more kinds In addition, ceramics, some of which are substituted with a clay before organic modification and a clay after organic modification, may be used as an alternative to the ceramics. The ceramics are also provided with oxidation resistance, and have a strong resistance with respect to the oxidation environment in the vicinity of the electrode, particularly, the positive electrode during charging when the heat resistant microporous membrane is used as a battery separator. The shape of the ceramics is not particularly limited, and any of a spherical shape, a fibrous shape, and a random shape may be used.

The average particle diameter of the primary particles in the ceramics is preferably several μm or smaller from the viewpoint of the effect on the strength of the separator and the flatness of the coated surface. Specifically, the average particle diameter of the primary particles is preferably 1.0 μm or smaller, more preferably 0.5 μm or smaller, and further preferably 0.1 μm or smaller. The average particle diameter of the primary particles can be measured by a method in which photographs obtained using an electronic microscope are analyzed using a particle diameter measuring instrument.

When the average particle diameter of the primary particles of the ceramics exceeds 1.0 μm, there are cases in which the ceramics become brittle, and the coated surface becomes coarse. In addition, when the surface layer 3 including the ceramics is formed on the base material layer 2 by coating in a case in which the primary particles of the ceramics are too large, there is concern that a coating fluid including the ceramics may not coat the entire base material layer.

In addition, the amount of the ceramics added to the surface layer 3 is preferably 80% by weight to 95% by weight with respect to the total weight of the ceramics and the heat resistant resin in the surface layer 3. When the added amount of the ceramics is less than 80% by weight with respect to the total weight of the ceramics and the heat resistant resin, the heat resistance, oxidation resistance, and shrink resistance become low in the surface layer 3. In addition, when the added amount of the ceramics exceeds 95% by weight with respect to the total weight of the ceramics and the heat resistant resin, it becomes difficult to form the surface layer 3, which is not preferable.

[Clay Mineral]

The clay mineral included in the surface layer 3 of the present disclosure improves the mechanical characteristics and heat resistance of the surface layer 3. In addition, the clay mineral also has an effect of improving the adhesiveness between the surface layer 3 and the base material layer 2.

The clay mineral is an inorganic compound forming a lamellar shape, and a material having a lamellar structure in which an organic modifier is physically and chemically bonded on the surface is used. Examples of the clay minerals that can be used include lamella silicates (Si—Al-based, Si—Mg-based, Si—Al—Mg-based, Si—Ca-based, and the like). Here, the lamellar silicates refer to substances having a lamellar structure configured by laminating a number of layers. A certain substance in the above layers is formed by combining a number of tetrahedrons composed of silicic acid in the planar direction or formed by combining a number of octahedrons including aluminum or magnesium in the planar direction. Such lamellar silicates may be naturally-derived silicates, treated natural silicates, or artificially manufactured (synthesized) synthetic materials.

Typical examples of the lamellar silicates include kaolinite groups, such as kaolinite, nacrite, and halloysite, smectite groups, such as montmorillonite, hydelite, saponite, hectorite, and mica, and vermiculite groups. Only one of the above may be used, or two or more may be used jointly. In addition, the lamellar silicates are not limited thereto in the present disclosure.

Specifically, materials, such as mica, mica fluoride, and bentonite, may be preferably used. Particularly, mica fluoride can obtain a large effect of improving mechanical characteristics and heat characteristics since the aspect ratio is large due to the high crystallinity, and the interaction with polyvinylidene fluoride can be obtained from the polarized structure.

The organic modifier that modifies the surface of the clay mineral substitutes all or some metal ions disposed between the layers of the clay mineral with organic onium ions, thereby modifying the surface. Examples of the organic onium ions that can be used include pyridinium ions, phosphonium ions, and sulfonium ions as well as ammonium ions, such as hexylammonium ions, dodecylammonium ions, octylammonium ions, stearyl ammonium ions, and octa decyl ammonium ions. Only one of the above may be used, or two or more may be used jointly.

In addition, there is demand for the organic modifier to have an interaction with the heat resistant resin and an affinity to the electrolytic solution as well as the dispersibility with respect to the heat resistant resin, such as polyvinylidene fluoride. It is preferable that the organic modifier be appropriately selected by a user who uses the organic modifier. When polyvinylidene fluoride is used as the heat resistant resin, and alumina is used as the ceramics, organic modifiers having a functional group, such as a hydroxyl group, a carboxyl group, a sulfonic group, and a phosphate group, are preferred for the interaction with (functional group-containing) polyvinylidene fluoride or alumina, or the adhesiveness with the base material. The clay mineral can be dispersed evenly, and the adhesiveness with alumina is improved by a polar group having a high affinity to the clay mineral that is coordinated at the surface basic sites in alumina. In addition, when polyvinylidene fluoride has a polar group as well, polyvinylidene fluoride is bound by the interaction so that the bonding force between molecular chains is enhanced.

Furthermore, there is demand for the organic modifier to have adhesiveness and wetting properties with respect to the base material composed of a heat resistant resin, such as polyolefin resin. Favorable wetting properties of a resin solution with respect to the base material layer 2 or an increase in the adhesiveness by a large intermolecular action between the base material layer 2 and the surface layer 3 improves the separation strength between the base material layer 2 and the surface layer 3 when the surface layer 3 is formed on the base material layer 2. Thereby, the adhesiveness between the base material layer 2 and the surface layer 3 provided with dimensional stability by high mechanical characteristics and heat resistance becomes large, and thermal shrinkage of the base material layer 2 is physically suppressed, and therefore thermal shrinkage is suppressed across the microporous membrane. Inclusion of alkyl chains in the molecules of the clay mineral can improve the adhesiveness by the interaction between the alkyl chains and the polyolefin-based resin, which is the base material.

Examples of the clay minerals that can be preferably used include mica fluoride organically modified by bis(2-hydroxyethyl)methyldodecylammonium ions or bentonite organically modified by oleyl bis(2-hydroxyethyl)methylammonium.

The average particle diameter of the clay mineral is preferably 1.0 μm or smaller, and more preferably 0.5 μm or smaller.

In addition, the clay mineral is preferably included at 1% by weight to 10% by weight with respect to the total weight of the heat resistant resin and the clay mineral, and more preferably at 3% by weight to 10% by weight.

The adhesiveness (separation strength) between the base material layer 2 and the surface layer 3 seems to have a relationship with the work of adhesion computed from the surface free energy of the surface layer 3. That is, when the work of adhesion computed from the surface free energy of the surface layer 3 is large, the separation strength between the base material layer 2 and the surface layer 3 is also strong, and the adhesiveness is increased.

The surface free energy of the surface layer 3 can be computed based on, for example, the theory by Kitazaki and Hata. In this method, three kinds of liquid having already-known surface free energies are used, the contact angles of the respective liquids with respect to the surface layer 3 are obtained, and then the surface free energy of the surface layer 3 can be computed using the contact angles. Water, diiodomethane, and ethylene glycol are used as the three kinds of liquid. In addition, the work of adhesion with the base material layer 2 can be computed from the computed surface free energy. The surface energy, dispersed components, dipole components, hydrogen-bonded components, and work of adhesion can be computed based on a written reference by Kitazaki and the like (by Yasuaki Kitazaki and Toshio Hata, the Journal of the Adhesion Society of Japan, 8(3), 131, (1972)) using a surface free energy analyzing software, such as the comprehensive analysis software FAMAS, manufactured by Kyowa Interface Science Co., Ltd.

Preferable examples of the organic modifier include bis(2-hydroxyethyl)methyl dodecyl ammonium ions, trimethylstearylammonium, trioctylmethylammonium, trioctylammonium, oleylbis(2-hydroxyethyl)methylammonium, alkylene oxide compounds, stearyltrimethylammonium, dimethyl dioctadecyl ammonium, fatty acid ammonium chloride, and the like. Among the above, bis(2-hydroxyethyl)methyl dodecyl ammonium ions and oleylbis(2-hydroxyethyl)methylammonium are particularly preferred. This is because they have both a hydroxyl group and an alkyl group, and have a high interaction with the heat resistant resin and the ceramics in the surface layer 3, and a high adhesiveness with the base material layer 2.

The structure of the bis(2-hydroxyethyl)methyl-dodecyl ammonium ion is shown as an example of the organic modifier.

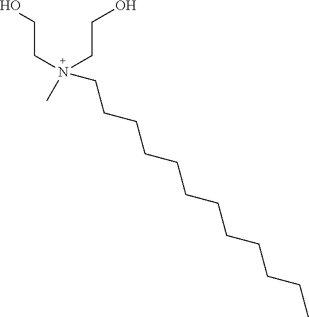

The hydroxyl groups of bis(2-hydroxyethyl)methyl dodecyl-ammonium ion bond with the surface basic sites of alumina in the surface layer 3. Thereby, the adhesiveness between bis(2-hydroxyethyl)methyl-dodecyl-ammonium-ions and alumina is improved. In addition, the dodecyl group of the bis(2-hydroxyethyl)methyl-dodecyl-ammonium-ion can improve the wetting properties with a polyolefin-based resin, such as polyethylene, in the base material layer 2, and the intermolecular force.

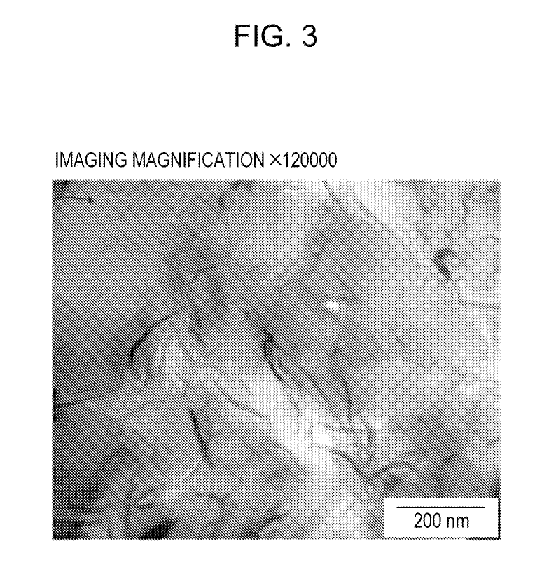

FIG. 2 is a schematic view showing the shape of the clay mineral whose surface is modified by the heat resistant resin and the organic modifier in the surface layer 3. In addition, FIG. 3 is a TEM image observed using a transmission electron microscope (TEM) of a 100 nm-thick section of a resin film cut out using a microtome, in which bentonite is mixed with and dispersed in polyvinylidene fluoride so that the mass percent concentration of bentonite becomes 5%.

FIG. 2 is a schematic view showing the relationship between the clay mineral and the heat resistant resin in the surface layer 3. The clay mineral dispersed in a state in which several layers are laminated sandwiches the heat resistant resin between the clay mineral dispersed by the interaction between the organic modifier and the heat resistant resin. The heat resistant resin moves freely, but is sandwiched between the clay mineral so that the movement is hindered. Thereby, the heat resistant resin becomes hard, and the coefficient of elasticity becomes high. That is, the mechanical characteristics of the surface layer 3 are improved.

In addition, when the temperature of the heat resistant resin is increased, the molecular movement becomes violent due to heat in the heat resistant resin, but the heat resistant resin is sandwiched between the clay mineral as described above, and therefore the molecular movement is hindered. Thereby, the softening point of the heat resistant resin is increased, and the heat resistance of the surface layer 3 is improved.

Such an effect becomes large as the aspect ratio of the clay mineral dispersed in the heat resistance resin is increased, or the compatibility between the surface of the clay mineral and the heat resistant resin improves. Specifically, the aspect ratio of the clay mineral dispersed in the heat resistant resin is preferably 15 or higher. This is because the clay mineral can more efficiently sandwich the heat resistant resin as the aspect ratio of the dispersed clay mineral is increased, or the interaction between the clay mineral and the heat resistant resin becomes strong as the compatibility between the surface of the clay mineral and the heat resistant resin improves.

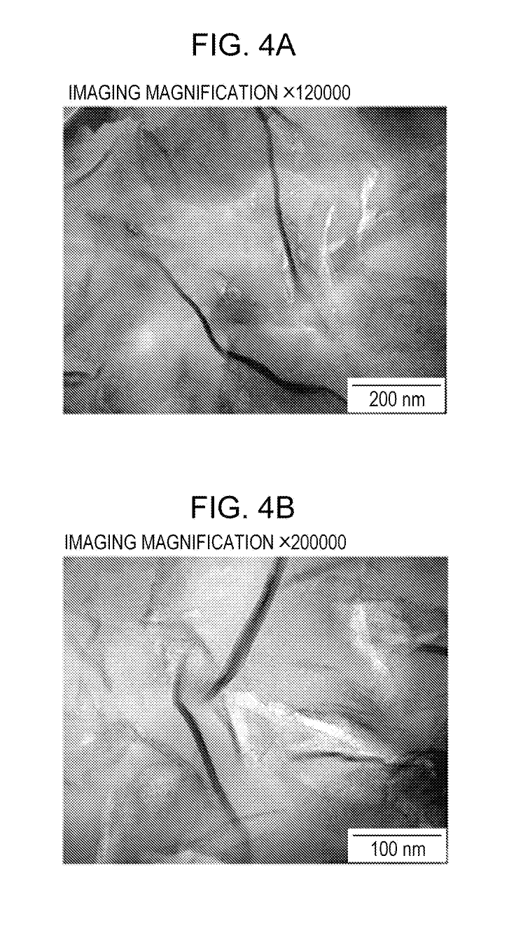

FIG. 4A and FIG. 4B are TEM images observed using a transmission electron microscope of bentonite in a resin film formed by dispersing bentonite in polyvinylidene fluoride. In the resin film in FIG. 4A and FIG. 4B, bentonite (manufactured by Southern Clay Products, Inc., Claytone APA (registered trade mark)), in which polyvinylidene fluoride (KF Polymer W#9300, manufactured by Kureha Corporation) as the heat resistant resin is organically modified by fatty acid ammonium chloride as the clay mineral, is used.

In addition, the imaging magnification is 120000 times in FIG. 4A, and the imaging magnification is 200000 times in FIG. 4B. The bentonite has an average long diameter of 191 nm, an average short diameter of about 10 nm, and an aspect ratio of 19 in the resin film in FIG. 4A and FIG. 4B.

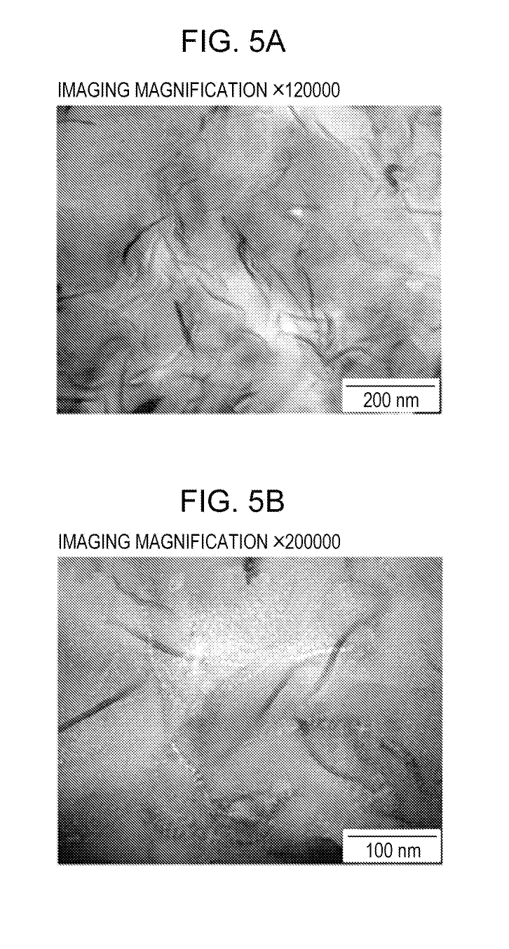

FIG. 5A and FIG. 5B are TEM images observed using a transmission electron microscope of mica fluoride in a resin film formed by dispersing mica fluoride in polyvinylidene fluoride. In the resin film in FIG. 5A and FIG. 5B, mica fluoride (manufactured by Coop Chemical Co., Ltd., SOMASIF MEE (registered trade mark)), in which polyvinylidene fluoride (KF Polymer W#9300, manufactured by Kureha Corporation) as the heat resistant resin is organically modified by bis(2-hydroxyethyl)methyl dodecyl ammonium as the clay mineral, is used. In addition, the imaging magnification is 120000 times in FIG. 5A, and the imaging magnification is 200000 times in FIG. 5B. The mica fluoride has an average long diameter of 303 nm, an average short diameter of about 10 nm, and an aspect ratio of 30 in the resin film in FIG. 5A and FIG. 5B.

In addition, the above effect becomes larger by adjusting the interlayer distance (surface interval) of the clay mineral denatured by the organic modifier before being dispersed in the heat resistant resin. Specifically, the interlayer distance (surface interval) of the clay mineral denatured by the organic modifier is preferably 0.9 nm to 1.4 nm before being dispersed in the heat resistant resin. This is because, when the interlayer distance (surface interval) is 0.9 nm to 1.4 nm, the heat resistant resin can easily move in between the layers of the clay mineral, and therefore the dispersibility of the clay mineral is improved.

Here, the interlayer distance (h0) of the clay mineral can be computed based on the following formula.

h0 (nm)=d (nm)−0.95 (1)

In the formula (1), the “0.95” nm is the thickness of one layer of denatured lamellar silicate, and the value barely changes regardless of the denatured lamellar silicate used. The “d” can be computed by the X-ray diffraction measurement using the Bragg's equation of the following formula (2) from the peak point (20) that corresponds to the bottom face reflection of the 001 face of the denatured lamellar silicate.

d=λ/2 sin θ (2)

(In the formula (2), the “λ” is the wavelength of the incident X-ray, for example, λ=0.154 nm. The “θ” is the incident angle of the X-ray.)

The interlayer distance h0 can be controlled by the chain length when, for example, the organic modifier is used as a denaturing agent. Generally, the h0 is decreased as the chain length of the organic modifier becomes shorter. As the interlayer distance h0 becomes small, and the polarity of the organic modifier becomes large, accordingly, the heat resistant resin can easily move in between the layers. When a cationic organic modifier is used, it is possible to change the h0 by the head group (primary, secondary, or tertiary) of an ammonium salt. In addition, even when the same organic modifier is used, the “h0” can be controlled by using lamellar silicates having different charge exchange capacities (CEC).

The clay mineral is configured by laminating a number of layers as described above. The clay mineral is largely classified into two types as follows depending on the dispersibility in the heat resistant resin.

(i) Layer Separation Type

The layer separation-type clay mineral is separated into a state in which a single layer or 2 to 4 layers are laminated and dispersed in the surface layer 3 when the clay mineral is mixed with the heat resistant resin. The clay mineral separated into a state in which several layers are laminated is separated until the thickness (short side) in the lamination direction becomes about several nm to several tens of nm.

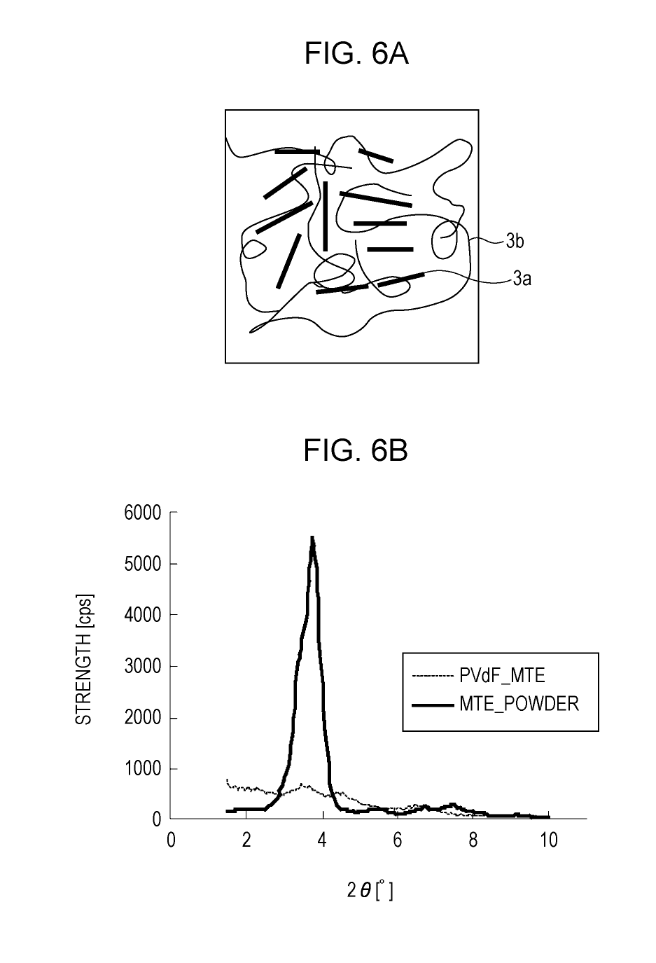

FIG. 6A is a schematic view of the dispersion state of the layer separation-type clay mineral 3a and the heat resistant resin 3b in the surface layer 3. In addition, FIG. 6B is a graph showing the evaluation of the dispersion states of the layer separation-type clay mineral before being mixed with the heat resistant resin and when the layer separation-type clay mineral is dispersed in the heat resistant resin. FIG. 6B is the evaluation when mica fluoride (manufactured by Coop Chemical Co., Ltd., SOMASIF MTE (registered trade mark)), in which polyvinylidene fluoride (KF Polymer W#9300, manufactured by Kureha Corporation) as the heat resistant resin is organically modified by bis(2-hydroxyethyl)methyl dodecyl ammonium as the clay mineral, is used.

The solid line in FIG. 6B shows the evaluation by the X-ray diffraction method (XRD) of the peak that corresponds to the interlayer distance (surface interval) of mica fluoride powder before the mica fluoride is dispersed in polyvinylidene fluoride, and shows the diffraction intensity with respect to the diffraction angle 2θ of the X-ray. In addition, the dotted line in FIG. 6B shows the evaluation by the X-ray diffraction method (XRD) of the peak that corresponds to the interlayer distance (surface interval) of mica fluoride powder in the resin film formed by mixing polyvinylidene fluoride and mica fluoride in 95:5 (weight ratio) and dispersing the mica fluoride.

As shown in FIG. 6B, the peak of the 001 face of the clay mineral powder before dispersion can be obtained by the X-ray diffraction method from the layer separation-type clay mineral, but the peak of the 001 face of the clay mineral powder after dispersion is lost. That is, it is found that the layer composing the clay mineral is separated and dispersed.

(ii) Interlayer Insertion Type

The interlayer insertion-type clay mineral allows the heat resistant resin to be inserted between the respective layers that compose the clay mineral in the surface layer 3 when mixed with the heat resistant resin, thereby increasing the interlayer distance of the respective layers.

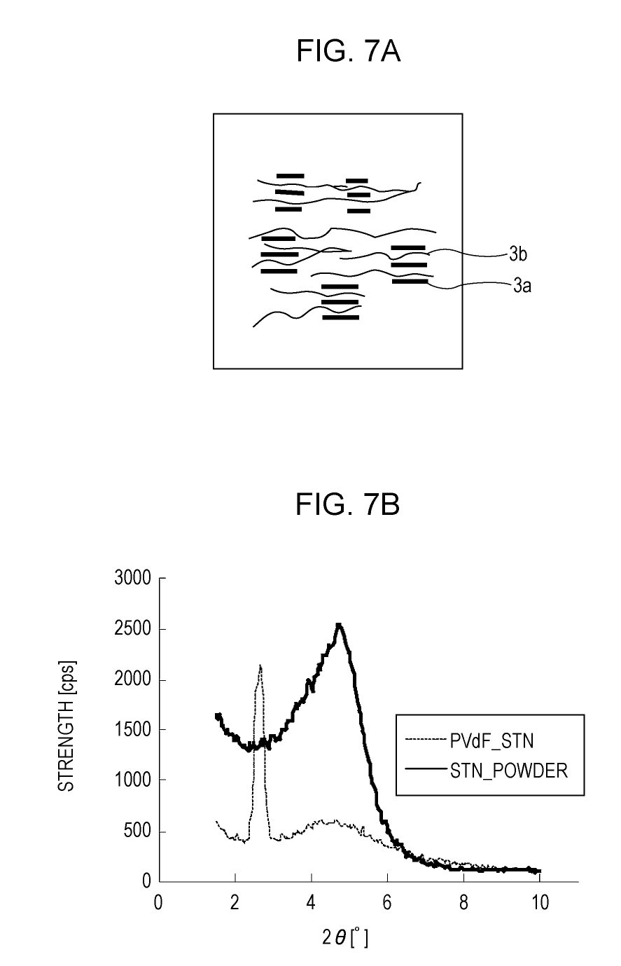

FIG. 7A is a schematic view of the dispersion state of the interlayer insertion-type clay mineral 3a and the heat resistant resin 3b in the surface layer 3. In addition, FIG. 7B is a graph showing the evaluation of the dispersion state of the interlayer insertion clay mineral before being mixed with the heat resistant resin and of the dispersion state when the interlayer insertion clay mineral is dispersed in the heat resistant resin. FIG. 7B shows the evaluation where bentonite (manufactured by Coop Chemical Co., Ltd., LUCENTITE STN (registered trade mark)), in which polyvinylidene fluoride (KF Polymer W#9300, manufactured by Kureha Corporation) as the heat resistant resin is organically modified by trioctylammonium as the clay mineral, is used.

The solid line in FIG. 7B shows the evaluation by the X-ray diffraction method (XRD) of the peak that corresponds to the interlayer distance (surface interval) of bentonite powder before the bentonite is dispersed in polyvinylidene fluoride, and shows the diffraction intensity with respect to the diffraction angle 2θ of the X-ray. In addition, the dotted line in FIG. 7B shows the evaluation by the X-ray diffraction method (XRD) of the peak that corresponds to the interlayer distance (surface interval) of bentonite in the resin film formed by mixing polyvinylidene fluoride and bentonite at 95:5 (weight ratio) and dispersing the bentonite.

As shown in FIG. 7B, the peak of the 001 face of the clay mineral powder before dispersion can be obtained by the X-ray diffraction method from the interlayer insertion-type clay mineral. In addition, the peak of the 001 face of the clay mineral powder is not lost after dispersion and shifted to low angles. That is, it is found that the interlayer distance h0 of the layers composing the clay mineral is increased since the diffraction angle 2θ is less than 90°.

The thickness of the surface layer 3 may be arbitrarily set as long as the thickness is thick enough to have the necessary heat resistance. When the heat resistant microporous membrane 1 is used as a battery separator, the surface layer 3 is preferably set to a thickness that achieves insulation between the positive electrode and the negative electrode, provides the necessary heat resistance as a separator, has ion permeability for preferably carrying out a battery reaction through the heat resistant microporous membrane 1, and can increase as much as possible the volume efficiency of an active material layer that contributes to the battery reaction in the battery. Specifically, the thickness of the surface layer 3 is preferably 1 μm to 3 μm. In addition, the porosity in the surface layer 3 is preferably 60% to 70% in order to obtain the ion permeability.

In a battery separator composed of the shrink resistant microporous membrane of the present disclosure, the surface layer of the shrink resistant microporous membrane is preferably provided on a surface that faces at least the positive electrode. The vicinity of the positive electrode is highly oxidizing during charging. Therefore, the ceramics included in the surface layer may offer the anti-oxidation effect of the surface layer so that degradation of the separator can be suppressed.

As shown above, the resin film having the clay mineral of the present disclosure dispersed in the heat resistant resin has superior mechanical characteristics and heat resistance to a resin film formed only of the heat resistant resin, but the surface layer having the ceramics and the clay mineral of the present disclosure dispersed in the heat resistant resin has even more superior characteristics. The improvement of the characteristics results from not only the effects of heat resistance, anti-oxidation, and the like by the dispersion of the ceramics but also the interaction of the clay mineral, the heat resistant resin and the ceramics of the present disclosure which operate therebetween. In addition, the shrink resistant microporous membrane of the first embodiment has the surface layer 3, which is a resin layer having the ceramics and the clay mineral of the present disclosure dispersed in the heat resistant resin, formed on the surface of the base material layer 2. Thereby, the separation strength between the surface layer 3 and the base material layer 2 is improved. Therefore, the thermal shrinkage of the base material layer 2 is suppressed by adhesion with the surface layer 3 that provides dimensional stability due to the high mechanical characteristics and heat resistance.

Here, the weight per unit area of the shrink resistant microporous membrane is preferably 40 g/m² or lower, and more preferably 15 g/m² or lower when the shrink resistant microporous membrane is used as a battery separator. The porosity of the shrink resistant microporous membrane is determined by the permeability of electrons and ions, the material, or the thickness, but is, in general, preferably in a range of 30% to 80%, and more preferably 35% to 50%. This is because the ion conductivity is lowered when the porosity is low, and a short-circuit occurs between the positive electrode and the negative electrode when the porosity is high.

In addition, the thickness of the shrink resistant microporous membrane is preferably in a range of, for example, 10 μm to 300 μm, more preferably in a range of 15 μm to 70 μm, and further preferably in a range of 15 μm to 25 μm when the shrink resistant microporous membrane is used as a battery separator. When the thickness of the shrink resistant microporous membrane is thin, there are cases in which a short-circuit occurs between the positive electrode and the negative electrode. On the other hand, when the thickness of the shrink resistant microporous membrane is thick, the amount of the active material packed in the battery is lowered, and thus the battery capacity is degraded.

In a battery separator composed of the shrink resistant microporous membrane of the present disclosure, the surface layer of the shrink resistant microporous membrane is preferably provided on a surface that faces at least the positive electrode. The vicinity of the positive electrode is highly oxidizing during charging. Therefore, the ceramics included in the surface layer may offer the anti-oxidation effect to the surface layer so that degradation of the separator can be suppressed.

(1-2) Method of Manufacturing the Shrink Resistant Microporous Membrane

An example of the method of manufacturing the shrink resistant microporous membrane according to the first embodiment will be described.

Firstly, a heat resistant resin and a clay mineral are added to and dissolved in a heat resistant resin and a dispersion solvent, such as N-methyl-2-pyrolidone, thereby obtaining a resin solution. Next, the resin solution is injected in a disperser, and the clay mineral in the resin solution is dispersed using the disperser. Thereby, a dispersion solution in which the clay mineral is sufficiently dispersed so that the layer of the clay mineral is separated can be obtained.

Subsequently, a predetermined amount of the fine powder of a ceramic is added to the dispersion solution including the heat resistant resin and the clay mineral, and, furthermore, stirred using a crushing mill, thereby obtaining a slurry for forming the surface layer. After that, the slurry for forming the surface layer obtained in the above manner is coated using a doctor blade or the like and dried on one surface or both surfaces of the base material layer 2 composed of a polyolefin microporous membrane or the like. Furthermore, the base material layer 2 coated with the slurry for forming the surface layer is brought into a water bath, separated into phases, and dried using hot air. Thereby, a shrink resistant microporous membrane composed of the base material layer 2 which is composed of the polyolefin microporous membrane, and the surface layer 3 that includes a heat resistant resin, for example, a nano-order-size clay mineral and the ceramics dispersed in a state in which layers are separated and has an interconnected porous structure can be obtained.

Meanwhile, examples of the disperser that can be used include a paint shaker, a bead mill, a sand grind mill, a ball mill, an attritor mill, a two-roll mill, a stirrer, an ultrasonic disperser, and the like. The dispersion time varies with the concentration and kind of materials to be dispersed, but is about 1 hour to 10 hours when a bead mill, a stirrer, and an ultrasonic disperser are used. The particle diameter of particles can be finer as the crushing time is extended. At this time, heating may be carried out for improvement of dispersibility.

In addition, a solvent that can dissolve the heat resistant resin and finely disperse the clay mineral is used as the dispersion solvent. When polyvinylidene fluoride is used as the heat resistant resin, N-methyl-2-pyrrolidone (NMP), dimethylacetamide, dimethylformamide, dimethyl sulfoxide, toluene, and the like can be used as the dispersion solvent, but N-methyl-2-pyrolidone is preferably used from the viewpoint of solubility and high dispersibility.

### EXAMPLES

Hereinafter, the examples and the comparative examples of the present disclosure will be described in more detail.

### Example 1

### Confirmation of the Mechanical Characteristics and Heat Resistance of the Resin Film by the Addition of the Clay Mineral

In Example 1, a resin film formed by adding and dispersing a clay mineral in a heat resistant resin was manufactured, the dispersibility of the clay mineral was confirmed, and it was confirmed that the strength and heat resistance of the resin film in which the clay mineral was dispersed were improved.

<Sample 1-1>

A maleic acid denatured polyvinylidene fluoride resin (KF Polymer W#9300, manufactured by Kureha Corporation (average molecular weight of one million)) as the heat resistant resin and mica fluoride (manufactured by Coop Chemical Co., Ltd., SOMASIF MEE), which is a denatured lamellar silicate, as the clay mineral were mixed in a weight ratio of 95:5 and sufficiently dissolved in N-methyl-2-pyrrolidone, thereby manufacturing a polyvinylidene fluoride solution in which 4% by weight of polyvinylidene fluoride was dissolved. Here, the interlayer distance of the mica fluoride before dispersion, which was measured by detecting the peak that corresponds to the bottom face reflection of the 001 face by the X-ray diffraction method (XRD), was 1.1 nm.

Next, the polyvinylidene fluoride solution was stirred and mixed using a bead mill having a diameter of 0.65 mm, thereby manufacturing a dispersion solution in which mica fluoride was dispersed. Subsequently, the dispersion solution was cast in a glass Petri dish and dried at 130° C. for 4 hours. After that, the dried film was immersed in a water bath for 15 minutes so as to be separated, and then dried using hot air, thereby manufacturing a 20 μm-thick polyvinylidene fluoride film. Meanwhile, as a result of measuring the dispersibility of the mica fluoride in the manufactured polyvinylidene fluoride film by the X-ray diffraction method (XRD), it was confirmed that the peak that corresponded to the bottom face reflection of the 001 face was lost, and the film was the separation type.

<Sample 1-2>

A polyvinylidene fluoride film was manufactured in the same manner as Sample 1-1 except that bentonite (manufactured by Hojun Kogyo Co., Ltd., ORGANITE T (registered trade mark)) was used as the denatured lamellar silicate. Here, the interlayer distance of the bentonite before dispersion, which was measured by the X-ray diffraction method (XRD), was 0.9 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-3>

A polyvinylidene fluoride film was manufactured in the same manner as Sample 1-1 except that mica fluoride (manufactured by Coop Chemical Co., Ltd., SOMASIF MEE) was used as the denatured lamellar silicate. Here, the interlayer distance of the mica fluoride before dispersion, which was measured by the X-ray diffraction method (XRD), was 1.4 nm. In addition, as a result of measuring the dispersibility of the mica fluoride in the polyvinylidene fluoride film by the X-ray diffraction method (XRD), it was confirmed that the peak that corresponded to the bottom face reflection of the 001 face was lost, and the film was the separation type.

<Sample 1-4>

A polyvinylidene fluoride film was manufactured in the same manner as Sample 1-1 except that bentonite (manufactured by Coop Chemical Co., Ltd., LUCENTITE STN) was used as the denatured lamellar silicate. Here, the interlayer distance of the bentonite before dispersion, which was measured by the X-ray diffraction method (XRD), was 0.9 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-5>

A polyvinylidene fluoride film was manufactured in the same manner as Sample 1-1 except that bentonite (manufactured by Southern Clay Products, Inc., Claytone APA) was used as the denatured lamellar silicate. Here, the interlayer distance of the bentonite before dispersion, which was measured by the X-ray diffraction method (XRD), was 1.0 nm. In addition, as a result of measuring the dispersibility of the bentonite in the polyvinylidene fluoride film by the X-ray diffraction method (XRD), it was confirmed that the peak that corresponded to the bottom face reflection of the 001 face was lost, and the film was the separation type.

<Sample 1-6>

A polyvinylidene fluoride film was manufactured in the same manner as Sample 1-1 except that bentonite (manufactured by Hojun Kogyo Co., Ltd., ESBEN NO125 (registered trade mark)) was used as the denatured lamellar silicate. Here, the interlayer distance of the bentonite before dispersion, which was measured by the X-ray diffraction method (XRD), was 0.9 nm. In addition, as a result of measuring the dispersibility of the bentonite in the polyvinylidene fluoride film by the X-ray diffraction method (XRD), it was confirmed that the peak that corresponded to the bottom face reflection of the 001 face was lost, and the film was the separation type.

<Sample 1-7>

A polyvinylidene fluoride film was manufactured in the same manner as Sample 1-1 except that mica fluoride (manufactured by Coop Chemical Co., Ltd., LUCENTITE SEN (registered trade mark)) was used as the denatured lamellar silicate. Here, the interlayer distance of the bentonite before dispersion, which was measured by the X-ray diffraction method (XRD), was 1.4 nm. In addition, as a result of measuring the dispersibility of the bentonite in the polyvinylidene fluoride film by the X-ray diffraction method (XRD), it was confirmed that the peak that corresponded to the bottom face reflection of the 001 face was lost, and the film was the separation type.

<Sample 1-8>

A polyvinylidene fluoride film was manufactured in the same manner as Sample 1-1 except that mica (manufactured by Topy Industries Ltd., 4C-TS) was used as the denatured lamellar silicate. Here, the interlayer distance of the bentonite before dispersion, which was measured by the X-ray diffraction method (XRD), was 1.6 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-9>

A polyvinylidene fluoride film was manufactured in the same manner as Sample 1-1 except that bentonite (manufactured by Hojun Kogyo Co., Ltd., ESBEN NX (registered trade mark)) was used as the denatured lamellar silicate. Here, the interlayer distance of the bentonite before dispersion, which was measured by the X-ray diffraction method (XRD), was 2.3 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-10>

A polyvinylidene fluoride film was manufactured in the same manner as Sample 1-1 except that bentonite (manufactured by Southern Clay Products, Inc., Claytone HY (registered trade mark)) was used as the denatured lamellar silicate. Here, the interlayer distance of the bentonite before dispersion, which was measured by the X-ray diffraction method (XRD), was 2.7 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-11>

A polyvinylidene fluoride film was manufactured in the same manner as Sample 1-1 except that bentonite (manufactured by Southern Clay Products, Inc., Claytone AF (registered trade mark)) was used as the denatured lamellar silicate. Here, the interlayer distance of the bentonite before dispersion, which was measured by the X-ray diffraction method (XRD), was 2.4 nm. In addition, as a result of measuring the dispersibility of the bentonite in the polyvinylidene fluoride film by the X-ray diffraction method (XRD), it was confirmed that the peak that corresponded to the bottom face reflection of the 001 face was shifted, and the film was the interlayer insertion type.

<Sample 1-12>

A polyvinylidene fluoride film was manufactured in the same manner as Sample 1-1 except that no denatured lamellar silicate was added.

[Evaluation of the Polyvinylidene Fluoride Film]

(a) Measurement of the Coefficient of Tensile Elasticity

The coefficient of tensile elasticity was measured using a precision universal tester (manufactured by Shimazu Corporation, AG-100D) for each of the manufactured polyvinylidene fluoride films.

(b) Measurement of the Average Linear Expansion Coefficient and the Softening Point

The elongation of the polyvinylidene fluoride films was measured using a thermomechanical analyzer (manufactured by Seiko Instruments Inc., EXSTAR TMA/SS6000) for the polyvinylidene fluoride film of Sample 1-12 containing no clay mineral and the polyvinylidene fluoride film of Sample 1-1 containing mica fluoride as the clay mineral among the manufactured samples. At this time, the measurement was carried out while the temperature was increased at a rate of temperature increase set to 5° C./min as the measurement conditions of the thermomechanical analyzer.

Table 1 shows the evaluation results of Example 1

TABLE 1

| | | Lamellar silicate | | | | | | Coefficient | |
|---|---|---|---|---|---|---|---|---|---|
| | | | | | Surface | | | of | |
| | | | | | interval | | Coefficient | average | |
| | Heat | | Kind of | | before | | of tensile | linear | Softening |
| | resistant | | lamellar | | dispersion | | elasticity | expansion | point |
| | resin | Material | silicate | Organic modifier | [nm] | Dispersibility | [MPa] | ×10⁻⁵ | [° C.] |
| Sample | PVdF | SOMASIF | Mica | bis(2- | 1.1 | Separation | 2628 | 8.81 | 150 |
| 1-1 | | MEE | fluoride | Hydroxyethyl)methyl- | | type | | | |
| | | | | dodecylammonium ion | | | | | |
| Sample | | ORGNITE T | Bentonite | Trimethylstearylammonium | 0.9 | Insertion type | 2263 | — | — |
| 1-2 | | | | | | | | | |
| Sample | | SOMASIF | Mica | Trioctylmethylammonium | 1.4 | Separation | 2252 | — | — |
| 1-3 | | MTE | fluoride | | | type | | | |
| Sample | | LUCENTITE | Bentonite | Trioctylammonium | 0.9 | Insertion type | 2109 | — | — |
| 1-4 | | STN | | | | | | | |
| Sample | | Claytone | | Fatty acid ammonium chloride | 1.0 | Separation | 2102 | — | — |
| 1-5 | | APA | | | | type | | | |
| Sample | | ESBEN | | oleylbis(2- | 0.9 | Separation | 2102 | — | — |
| 1-6 | | NO12S | | hydroxyethyl)methylammonium, | | type | | | |
| | | | | alkylene oxide compounds | | | | | |
| Sample | | LUCENTITE | | Alkylene oxide compound | 1.4 | Separation | 2035 | — | — |
| 1-7 | | SEN | | | | type | | | |
| Sample | | 4C-TS | Mica | Stearyltrimethylammonium | 1.6 | Insertion type | 1978 | — | — |
| 1-8 | | | | | | | | | |
| Sample | | ESBEN NX | Bentonite | Dimethyl dioctadecyl | 2.3 | Insertion type | 1920 | — | — |
| 1-9 | | | | ammonium | | | | | |
| Sample | | Claytone | | Fatty acid ammonium chloride | 2.7 | Insertion type | 1738 | — | — |
| 1-10 | | HY | | | | | | | |
| Sample | | Claytone AF | | Fatty acid ammonium chloride | 2.4 | Insertion type | 1361 | — | — |
| 1-11 | | | | | | | | | |
| Sample | | — | — | — | — | — | 1415 | 17.59 | 140 |
| 1-12 | | | | | | | | | |

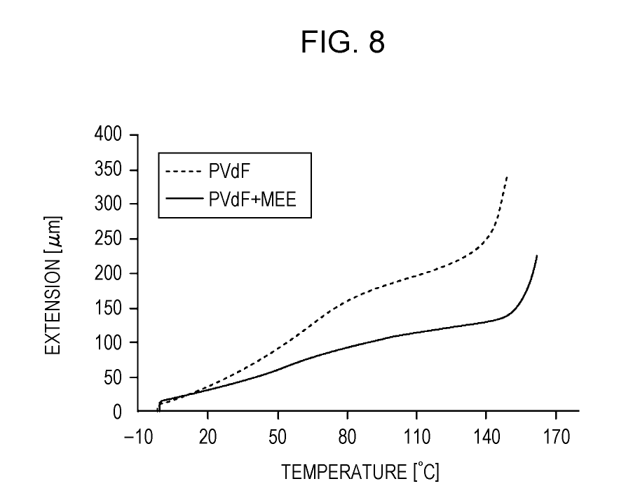

In addition, FIG. 8 is a graph showing the measurement results of the thermomechanical analyzer. In FIG. 8, the solid line shows the measurement results of Sample 1-1, and the dotted line shows the measurement results of Sample 1-12.

As shown in Table 1, the coefficients of tensile elasticity were improved in Samples 1-1 to 1-11, which were the resin films containing the clay mineral, in comparison to Sample 1-12, which was the resin film containing no clay mineral. There was a tendency for the coefficient of tensile elasticity to be increased as the clay mineral having a smaller interlayer distance before dispersion was used among them. It is considered that this is because the alkyl chain of the organic modifier in the clay mineral was short, and the polarity becomes high similarly to N-methyl-2-pyrrolidone, which is the dispersion solvent. It was found from Table 1 that it is particularly preferred to use a clay mineral having an interlayer distance before dispersion in a range of 0.9 nm to 1.4 nm.

In addition, there was a tendency for the coefficient of tensile elasticity to be increased when a layer separation-type material was used as the dispersion state of the clay mineral. This is because the clay mineral was separated into several layers and evenly diffused into the heat resistant resin, thereby evenly improving the characteristics across the entire surface of the resin film due to the diffusion of the clay mineral. Among them, the mica fluoride had a large aspect ratio and an increased reinforcement effect of the resin film. In addition, it is considered that the interaction with polyvinylidene fluoride was increased by fluorination.

As shown in FIG. 8, the softening point of the polyvinylidene fluoride film of Sample 1-12 was 140° C., but the softening point of the polyvinylidene fluoride film of Sample 1-1, which was formed by dispersing mica fluoride in polyvinylidene fluoride, was 150° C., which shows that the softening point was improved by 10° C. In addition, the average linear expansion coefficient of Sample 1-12 was 17.59×10⁻⁵/° C. in the temperature range of the above measurement (0° C. to 140° C.), but the average linear expansion coefficient of Sample 1-1 was 8.81×10⁻⁵/° C. in the same temperature range. That is, the softening point was improved, and the average linear expansion coefficient was 50% reduced in the resin films containing the clay mineral of the present disclosure in comparison to the resin films containing no clay mineral. Therefore, the surface layer 3 to which the clay mineral of the present disclosure is added has improved heat resistance.

### Example 2

### Confirmation of the Characteristics of the Resin Film with Respect to the Amount of the Clay Mineral Added

In Example 2, the strength of the resin film was confirmed by varying the amount of the clay mineral added to the heat resistant resin.

<Sample 2-1>

A polyvinylidene fluoride film was manufactured in the same manner as Sample 1-1 except that the mixed weight ratio of the maleic acid denatured polyvinylidene fluoride resin (KF Polymer W#9300, manufactured by Kureha Corporation (average molecular weight of one million)) to the mica fluoride (manufactured by Coop Chemical Co., Ltd., SOMASIF MEE), which is a denatured lamellar silicate, was 99:1.

<Sample 2-2> to <Sample 2-7>

Polyvinylidene fluoride films were manufactured in the same manner as Sample 1-1 except that the mixing weight ratios of the polyvinylidene fluoride resin to the mica fluoride were the weight ratios as shown in Table 2 below, respectively.

<Sample 2-8>

A polyvinylidene fluoride film was manufactured in the same manner as Sample 1-1 except that the mica fluoride was not mixed with the polyvinylidene fluoride resin.

[Evaluation of the Polyvinylidene Fluoride Film]

(a) Measurement of the Coefficient of Tensile Elasticity and Rupture Strength

The coefficient of tensile elasticity was measured using a precision universal tester (manufactured by Shimazu Corporation, AG-100D) for each of the manufactured polyvinylidene fluoride films. In addition, a load was added using a tensile tester, and the load when each of the samples was ruptured was obtained as the rupture strength.

(b) Measurement of the Coefficient of Storage Elasticity

The coefficient of storage elasticity was measured using a dynamic viscoelasticity measuring instrument (manufactured by IT Keisokuseigyo Corporation, DVA-220) for the polyvinylidene fluoride film of each of the manufactured samples. At this time, the measurement was carried out when the environment temperature was set to 25° C. and 150° C., respectively as the measurement condition.

(c) Measurement of Dimension Change Rate

The dimension change rates were measured before and after storage in a 150° C. environment for the polyvinylidene film of each of the manufactured samples. The dimension change rate was obtained from the dimension change of the polyvinylidene fluoride film after storage in a 150° C. environment with respect to the dimension of the polyvinylidene fluoride film before the storage in a 150° C. environment.

Dimension change rate [%]={(dimension before storage in a 150° C. environment−dimension after storage in a 150° C. environment)/dimension before storage in a 150° C. environment}×100

Table 2 shows the evaluation results of Example 2.

TABLE 2

| | | | | Dynamic viscoelasticity | | |
|---|---|---|---|---|---|---|
| | | | | | Coefficient of | 150° C. |
| | | Tensile test | | Coefficient of | storage | dimension |
| | | Coefficient of | Rupture | storage elasticity | elasticity at | change rate |
| | PVdF/MEE | elasticity [GPa] | strength [N] | at 25° C. [GPa] | 150° C. [GPa] | [%] |
| Sample | 99/1 | 1.48 | 15.02 | 2.12 | 0.11 | 2.9 |
| 2-1 | | | | | | |
| Sample | 97/3 | 1.61 | 19.61 | 2.39 | 0.33 | 1.9 |
| 2-2 | | | | | | |
| Sample | 95/5 | 2.08 | 19.46 | 3.05 | 0.32 | 2.2 |
| 2-3 | | | | | | |
| Sample | 93/7 | 2.37 | 19.79 | 3.30 | 0.65 | 1.9 |
| 2-4 | | | | | | |
| Sample | 90/10 | 2.93 | 19.13 | 4.55 | 1.17 | 1.7 |
| 2-5 | | | | | | |
| Sample | 88/12 | 3.27 | 6.09 | 4.60 | 1.18 | 1.7 |
| 2-6 | | | | | | |
| Sample | 85/15 | 4.04 | 5.60 | 4.90 | 1.18 | 2.0 |
| 2-7 | | | | | | |
| Sample | 100/0 | 1.19 | 10.95 | 1.69 | 0.09 | 3.5 |
| 2-8 | | | | | | |

As shown in Table 2, the coefficient of tensile elasticity and the coefficient of storage elasticity of the polyvinylidene fluoride films to which mica fluoride was added were increased as the added amount of mica fluoride was increased. On the other hand, it was found that the rupture strength of the polyvinylidene fluoride films was increased due to the addition of mica fluoride, but was decreased when the added amount exceeded 12% by weight. In addition, it was found that the value of the coefficient of storage elasticity at 150° C. was not improved even when the added amount exceeded 10% by weight.

Therefore, it was found that addition of mica fluoride improves the characteristics of the resin film. In addition, it was found that addition of more than 10% by weight of mica fluoride did not lead to even diffusion in polyvinylidene fluoride so that the improvement of the characteristics could not be expected from the values of the rupture strength and the coefficient of storage elasticity at 150° C. It was found that the added amount of mica fluoride was more preferably 1% by weight to 10% by weight.

### Example 3

### Confirmation of the Adhesiveness Between the Base Material and the Surface Layer with Respect to the Composition of the Surface Layer

In Example 3, the surface layers were formed with varied compositions of the surface layers, and the adhesiveness between the base material and the surface layer was confirmed in a microporous membrane composed of the base material and the surface layers formed on both surfaces of the base material.

<Sample 3-1>

A maleic acid denatured polyvinylidene fluoride resin (KF Polymer W#9300, manufactured by Kureha Corporation) as the heat resistant resin and mica fluoride (manufactured by Coop Chemical Co., Ltd., SOMASIF MEE), which is a denatured lamellar silicate, as the clay mineral were mixed in a weight ratio of 95:5, and sufficiently dissolved in N-methyl-2-pyrrolidone, thereby manufacturing a polyvinylidene fluoride solution in which 4% by weight of polyvinylidene fluoride was dissolved.

Next, the polyvinylidene fluoride solution was stirred and mixed using a bead mill having a diameter of 0.65 mm, thereby manufacturing a dispersion solution in which mica fluoride was dispersed. Subsequently, the fine powder of alumina (Al₂O₃, manufactured by Sumitomo Chemical Co., Ltd., AKP-3000 (registered trade mark)) having an average particle diameter of 500 nm was added as the ceramics to the dispersion solution so that the weight of the alumina became ten times the weight of polyvinylidene fluoride, and, furthermore, stirred using a bead mill, thereby manufacturing a coating slurry.

Next, the coating slurry was coated and dried on a 16 μm-thick polyethylene microporous membrane (manufactured by Tonen General Sekiyu K.K.), which is the base material, using a desk coater. Subsequently, the coating slurry was immersed in a water bath for 15 minutes and separated into phases, and then dried using hot air, thereby obtaining a microporous membrane having a surface layer composed of polyvinylidene fluoride microporous layers in which 2.25 μm-thick alumina was supported.

<Sample 3-2>

A microporous membrane was manufactured in the same manner as Sample 3-1 except that the surface layer contained no clay mineral.

<Sample 3-3>

A microporous membrane was manufactured in the same manner as Sample 3-1 except that the surface layer contained no ceramics.

<Sample 3-4>

A microporous membrane was manufactured in the same manner as Sample 3-1 except that the surface layer contained no ceramics and no clay mineral.

<Sample 3-5>

A microporous membrane was manufactured in the same manner as Sample 3-1 except that no surface layer was provided.

[Evaluation of the Microporous Membrane]

(a) Evaluation of the Surface Free Energy

The surface free energy on the surface layer of the microporous membrane of each of the samples was measured. Firstly, the contact angles of water, diiodomethane, and ethylene glycol with respect to the surface layer were measured, respectively, in order to compute the surface free energy based on the theory by Kitazaki and Hata. Next, the surface free energies were computed using the contact angles. Subsequently, the adhesive force with the polyethylene base material was computed by obtaining dispersed components, dipole components, and hydrogen-bonded components from the computed surface energy.

Meanwhile, the contact angles were measured using an automatic contact angle meter (manufactured by Kyowa Interface Science Co., Ltd., DM500). In addition, the surface energy, dispersed components, dipole components, hydrogen-bonded components, and work of adhesion were computed based on a written reference by Kitazaki and the like (by Yasuaki Kitazaki and Toshio Hata, the Journal of the Adhesion Society of Japan, 8(3), 131, (1972)) using a surface free energy analyzing software, such as the comprehensive analysis software FAMAS, manufactured by Kyowa Interface Science Co., Ltd.

In addition, the separation strength between the base material and the surface layer was measured using a separation strength measuring instrument (manufactured by Aikoh Engineering Co., Ltd., MODEL-1308) for the laminated microporous membrane of each of the manufactured samples.

Table 3 shows the evaluation results of Example 3.

TABLE 3

| | | | | | | Surface | | | | | |
|---|---|---|---|---|---|---|---|---|---|---|---|
| | | | Contact angle [°] | | | free | | | Hydrogen- | Work of | Separation |
| | Base | Surface layer | | Ethylene | | energy | Dispersed | Dipole | bonded | adhesion | strength |
| | material | configuration | Water | glycol | Diiodomethane | [mJ/m²] | component d | component p | component h | [mJ/m²] | [N/18 mm] |
| Sample | PE | PVdF/ | 112.2 | 56.8 | 64.1 | 29.4 | 29.4 | 0 | 0 | 51 | 2 |
| 3-1 | | alumina/ | | | | | | | | | |
| | | MEE 5 | | | | | | | | | |
| | | wt. % | | | | | | | | | |
| Sample | | PVdF/ | 119.5 | 63 | 67.3 | 25.1 | 25.1 | 0 | 0 | 47.9 | 1.5 |
| 3-2 | | alumina | | | | | | | | | |
| Sample | | PVdF/MEE | 68.2 | 59.1 | 47.1 | 69.8 | 18.8 | 42.4 | 8.6 | 47.3 | 1.9 |
| 3-3 | | 5 wt. % | | | | | | | | | |
| Sample | | PVdF | 93.8 | 52.3 | 62.6 | 32.1 | 31.2 | 0 | 0.9 | 53.5 | 2.8 |
| 3-4 | | | | | | | | | | | |
| Sample | | — | 111.6 | 82 | 66.7 | 23.1 | 22.9 | 0.2 | 0 | — | — |
| 3-5 | | | | | | | | | | | |

As shown in Table 3, a relationship was observed between the actually measured separation strength and the work of adhesion computed from the surface free energy. Therefore, it is considered that the addition of the clay mineral made the alkyl chains included in the surface modifier increased the dispersed component d of the surface free energy and increased the wetting properties between the coating slurry manufactured during the formation of the surface layer and the base material, and, consequently, the interaction between the base material and the surface layer was increased, and the separation strength was increased. Furthermore, it is considered that, when the surface modifier includes a polar group, the polar group is coordinated at the surface basic sites of alumina, and the amount of alkyl chains that can interact with the base material surface is increased.

Here, comparison between Sample 3-1 and Sample 3-2 shows that the addition of the clay mineral can produce a separation strength that is the same as or better than the separation strength when no clay mineral is added when the ceramics are included in the surface layer. In addition, it is considered that Sample 3-3 has a large separation strength, but has degraded heat resistance across the entire microporous membrane since no ceramics are included. In addition, it is considered that Sample 3-4 having the surface layer composed only of the heat resistant resin shows a larger separation strength, but is inferior in terms of the mechanical characteristics and heat resistance to Sample 3-3 since no clay mineral and no ceramics are included in the surface layer.

### Example 4

### Confirmation of the Characteristics of the Laminated Surface Layers with Respect to the Added Amount of the Clay Mineral

In Example 4, the surface layers were formed with varied mixed amounts of the clay mineral, and the shrinkage rate after high-temperature storage and air permeability of the microporous membrane were confirmed in a microporous membrane composed of the base material and the surface layers formed on both surfaces of the base material. Meanwhile, the surface layer contained the heat resistant resin, the clay mineral, and the ceramics in the microporous membrane of Example 4.

<Sample 4-1>

A maleic acid denatured polyvinylidene fluoride resin (KF Polymer W#9300, manufactured by Kureha Corporation (average molecular weight of one million)) as the heat resistant resin and mica fluoride (manufactured by Coop Chemical Co., Ltd., SOMASIF MEE), which is a denatured lamellar silicate, as the clay mineral were mixed in a weight ratio of 99:1, that is, the content of the mica fluoride became 1% by weight with respect to a mixture of the maleic acid denatured polyvinylidene fluoride resin and the mica fluoride, and sufficiently dissolved in N-methyl-2-pyrrolidone, thereby manufacturing a polyvinylidene fluoride solution in which 4% by weight of polyvinylidene fluoride was dissolved.

Next, the polyvinylidene fluoride solution was stirred and mixed using a bead mill having a diameter of 0.65 mm, thereby manufacturing a dispersion solution in which mica fluoride was dispersed. Subsequently, fine powder of alumina (Al₂O₃, manufactured by Sumitomo Chemical Co., Ltd., AKP-3000) having an average particle diameter of 500 nm was added as the ceramics to the dispersion solution so that the weight of the alumina became ten times the weight of polyvinylidene fluoride, that is, alumina: polyvinylidene fluoride: mica fluoride=990:99:1, and, furthermore, stirred using a bead mill, thereby manufacturing a coating slurry.

Next, the coating slurry was coated and dried on a 16 μm-thick polyethylene microporous membrane (manufactured by Tonen General Sekiyu K.K.), which is the base material, using a desk coater. Subsequently, the coating slurry was immersed in a water bath for 15 minutes and separated into phases, and then dried using hot air, thereby obtaining a microporous membrane having a surface layer composed of polyvinylidene fluoride microporous layers in which 2.25 μm-thick alumina was supported. In addition, the coating step was repeated on the rear surface side of the base material in the same manner, thereby forming a microporous membrane in which polyvinylidene fluoride microporous layers in which alumina was supported were formed on both surfaces.

### Example 4-2 to Example 4-6

Microporous membranes were manufactured in the same manner as Example 4-1 except that the contents of the mica fluoride were adjusted as shown in Table 4 below. Meanwhile, the mixed amount of the mica fluoride was adjusted to the mixed amount of the mica fluoride with respect to the mixture of the maleic acid denatured polyvinylidene fluoride resin and the mica fluoride as described in Example 4-1. In addition, the added amount of alumina was fixed to ten times with respect to the maleic acid polyvinylidene fluoride resin.

### Comparative Example 4-1

A 16 μm-thick polyethylene microporous membrane, which was the base material, was used without forming the surface layer.

### Comparative Example 4-2

A microporous membrane was manufactured in the same manner as Example 4-1 except that mica fluoride was not added to the surface layer.

[Evaluation of the Microporous Membrane]

(a) Measurement of the Shrinkage Rate after High-Temperature Storage

60 mm in the machine direction (MD) and 60 mm in the transverse direction (TD) of the microporous membrane of each of Examples and Comparative Examples was cut out and left to stand in a 150° C. oven for 1 hour. At this time, the microporous membrane was sandwiched by two sheets of paper and left to stand to prevent warm air from coming into direct contact with the microporous membrane. After that, the microporous membrane was taken out from the oven and cooled, and the lengths [mm] in the MD and the TD were measured, respectively. The thermal shrinkage rates in the MD and the TD were computed from the formulas below, respectively.

MD thermal shrinkage rate (%)=(60−the length of the microporous membrane after heating in the MD)/60×100

TD thermal shrinkage rate (%)=(60−the length of the microporous membrane after heating in the TD)/60×100

(b) Confirmation of the Dispersion State of the Mica Fluoride in the Surface Layer

The dispersion state of the mica fluoride in the surface layer was evaluated from the dispersibility of the mica fluoride in the microporous membrane in which the maleic acid denatured polyvinylidene fluoride resin and the mica fluoride were mixed in Example 2.

(c) Measurement of the Air Permeability

A time [min] for 100 cc of air to pass through the microporous membrane having an area of 645 mm² (a circle having a diameter of 28.6 mm) was measured using a JIS P8117-based Gurley's air permeability meter for Example 4-3, Comparative Example 4-1 and Comparative Example 4-2, and used as an air permeability measurement.

Table 4 shows the evaluation results of Example 4.

TABLE 4

| | | | Polyvinylidene | | | | | | | | |
|---|---|---|---|---|---|---|---|---|---|---|---|
| | | | fluoride | | Lamellar silicate | | | | | | |
| | | | | Weight- | | | Added | | | | |
| | | | | average | | | amount | Shrinkage | | Dispersion | Air |
| | Base | | | molecular | | | [% by | rate [%] | | state of clay | permeability |
| | material | Ceramics | Material | weight | Material | Dispersibility | weight] | MD | TD | mineral | [sec./100 cc] |
| Example 4-1 | PE | Alumina | Maleic | One | MEE | Separation type | 1 | 18.8 | 16.5 | ◯ | — |
| Example 4-2 | | | acid | million | | | 3 | 16.1 | 14.0 | ◯ | — |
| Example 4-3 | | | denatured | | | | 5 | 15.5 | 13.8 | ◯ | 405 |
| Example 4-4 | | | PVdF | | | | 10 | 13.0 | 10.7 | ◯ | — |
| Example 4-5 | | | | | | | 12 | 13.9 | 11.9 | Δ | — |
| Example 4-6 | | | | | | | 15 | 15.5 | 14.0 | Δ | — |
| Comparative | PE | — | — | — | — | — | — | 67.9 | 61.3 | — | 303 |
| Example 4-1 | | | | | | | | | | | |
| Comparative | | Alumina | Maleic | One | — | — | — | 19.3 | 17.1 | — | 393 |
| Example 4-2 | | | acid | million | | | | | | | |
| | | | denatured | | | | | | | | |
| | | | PVdF | | | | | | | | |

As shown in Table 4, it was found that the shrinkage rate after high-temperature storage was decreased in the surface layer to which mica fluoride was added in comparison to the polyethylene microporous membrane of Comparative Example 4-1, and the laminated microporous membrane of Comparative Example 4-2, in which the surface layer including polyvinylidene fluoride and alumina on the polyethylene base material was formed. It was found from Comparative Example 4-1 and Comparative Example 4-2 that the addition of alumina improved the heat resistance and decreased the shrinkage rate, but the shrinkage rate was further decreased when Comparative Example 4-2 was compared with other Examples. Therefore, an additional thermal shrinkage suppression effect by the addition of the clay mineral could be confirmed. In addition, with regard to the added amount, it was found that the dispersibility of the clay mineral with respect to polyvinylidene fluoride was degraded when more than 10% by weight of the clay mineral was added as shown in the results of Example 2. Therefore, the amount of the clay mineral added to the heat resistant resin is preferably 1% by weight to 10% by weight, and more preferably 3% by weight to 10% by weight.

### Example 5

### Confirmation of the Characteristics of the Laminated Surface Layers with Respect to the Kind of the Clay Mineral

In Example 5, the surface layers were formed with varied kinds of the clay mineral, and the shrinkage rate after high-temperature storage of the microporous membrane was confirmed in a microporous membrane composed of the base material and the surface layers formed on both surfaces of the base material. Meanwhile, the surface layer contained the heat resistant resin, the clay mineral, and the ceramics in the microporous membrane of Example 5.

<Sample 5-1>

A maleic acid denatured polyvinylidene fluoride resin (KF Polymer W#9300, manufactured by Kureha Corporation (average molecular weight of one million)) as the heat resistant resin and mica fluoride (manufactured by Coop Chemical Co., Ltd., SOMASIF MEE), which is a denatured lamellar silicate, as the clay mineral were used and mixed in a weight ratio of 95:5. Except this, a microporous membrane was manufactured in the same manner as Example 4-1.

### Example 5-2

A microporous membrane was manufactured in the same manner as Example 5-1 except that mica fluoride (manufactured by Coop Chemical Co., Ltd., SOMASIF MTE), which is a denatured lamellar silicate, was used as the clay mineral.

### Example 5-3

A microporous membrane was manufactured in the same manner as Example 5-1 except that bentonite (manufactured by Hojun Kogyo Co., Ltd., ESBEN NO₁₂S), which is a denatured lamellar silicate, was used as the clay mineral.

### Example 5-4

A microporous membrane was manufactured in the same manner as Example 5-1 except that bentonite (manufactured by Coop Chemical Co., Ltd., LUCENTITE STN), which is a denatured lamellar silicate, was used as the clay mineral.

### Example 5-5

A microporous membrane was manufactured in the same manner as Example 5-1 except that bentonite (manufactured by Hojun Kogyo Co., Ltd., ORGANITE T), which is a denatured lamellar silicate, was used as the clay mineral.

### Example 5-6

A microporous membrane was manufactured in the same manner as Example 5-1 except that bentonite (manufactured by Southern Clay Products, Inc. Claytone APA), which is a denatured lamellar silicate, was used as the clay mineral.

### Comparative Example 5-1

A 16 μm-thick polyethylene microporous membrane, which was the base material, was used without forming the surface layer.

### Comparative Example 5-2

A microporous membrane was manufactured in the same manner as Example 5-1 except that denatured lamellar silicate was not added to the surface layer.

[Evaluation of the Microporous Membrane]

(a) Measurement of the Shrinkage Rate after High-Temperature Storage

The thermal shrinkage rates in the MD and the TD were computed in the same manner as Example 4 for the microporous membrane of each of Examples and Comparative Examples.

Table 5 shows the evaluation results of Example 5.

TABLE 5

| | | | Polyvinylidene fluoride | | Lamellar silicate | | | Shrinkage | |
|---|---|---|---|---|---|---|---|---|---|
| | Base | | | Weight-average | | | Added amount | rate [%] | |
| | material | Ceramics | Material | molecular weight | Material | Dispersibility | [% by weight] | MD | TD |
| Example 5-1 | PE | Alumina | Maleic acid | One million | MEE | Separation type | 5 | 15.5 | 13.8 |
| Example 5-2 | | | denatured | | MTE | Separation type | | 18.0 | 15.3 |
| Example 5-3 | | | PVdF | | NO12S | Separation type | | 16.5 | 15.5 |
| Example 5-4 | | | | | STN | Insertion type | | 18.8 | 16.1 |
| Example 5-5 | | | | | ORGANITE T | Insertion type | | 18.9 | 15.4 |
| Example 5-6 | | | | | APA | Separation type | | 19.0 | 17.0 |
| Comparative | PE | — | — | — | — | — | — | 67.9 | 61.3 |
| Example 5-1 | | | | | | | | | |
| Comparative | | Alumina | Maleic acid | One million | — | — | — | 19.3 | 17.1 |
| Example 5-2 | | | denatured | | | | | | |
| | | | PVdF | | | | | | |

As shown in Table 5, it could be confirmed that the shrink suppression effect can be obtained by adding denatured lamellar silicate to the surface layer regardless of the kind of the material of the denatured lamellar silicate in the laminated microporous membrane composed of the base material and the surface layer including the heat resistant resin and the ceramics.

Particularly, the shrinkage rates were decreased in the microporous membranes of Example 5-1 to Example 5-3, in which denatured lamellar silicate having the layer separation-type dispersion form, in comparison to the microporous membranes of Example 5-4 to Example 5-6, in which denatured lamellar silicate having the interlayer insertion-type dispersion form. It is considered that this is because the lamellar silicate having a dispersion form of the layer separation type is evenly diffused in the surface layer, and therefore the effect of the addition of the lamellar silicate is evenly exhibited throughout the entire surfaces of the surface layer.

### Example 6

### Confirmation of the Characteristics of the Laminated Resin Films with Respect to the Kind of the Heat Resistant Resin

In Example 6, the surface layers were formed with varied kinds of the heat resistant resin, and the shrinkage rate after high-temperature storage of the microporous membrane was confirmed in a microporous membrane composed of the base material and the surface layers formed on both surfaces of the base material. Meanwhile, the surface layer contained the heat resistant resin, the clay mineral, and the ceramics in the microporous membrane of Example 6.

<Sample 6-1>

A maleic acid denatured polyvinylidene fluoride resin (KF Polymer W#9300, manufactured by Kureha Corporation) having an average molecular weight of one million as the heat resistant resin and mica fluoride (manufactured by Coop Chemical Co., Ltd., SOMASIF MEE), which is a denatured lamellar silicate, as the clay mineral were used and mixed in a weight ratio of 90:10. Except this, a microporous membrane was manufactured in the same manner as Example 4-1.

### Example 6-2

microporous membrane was manufactured in the same manner as Example 6-1 except that a maleic acid denatured polyvinylidene fluoride resin (manufactured by Kureha Corporation, KF Polymer W#9100) having an average molecular weight of 280,000 was used as the heat resistant resin.

### Example 6-3

A microporous membrane was manufactured in the same manner as Example 6-1 except that a polyvinylidene fluoride resin (KF Polymer W#7300, manufactured by Kureha Corporation) having an average molecular weight of one million was used as the heat resistant resin.

### Example 6-4

A microporous membrane was manufactured in the same manner as Example 6-1 except that a polyvinylidene fluoride resin (KF Polymer W#1100, manufactured by Kureha Corporation) having an average molecular weight of 280,000 was used as the heat resistant resin.

### Comparative Example 6-1

A 16 μm-thick polyethylene microporous membrane, which was the base material, was used without forming the surface layer.

### Comparative Example 6-2

A microporous membrane was manufactured in the same manner as Example 6-1 except that denatured lamellar silicate was not added to the surface layer.

[Evaluation of the Microporous Membrane]

(a) Measurement of the Shrinkage Rate after High-Temperature Storage

The thermal shrinkage rates in the MD and the TD were computed in the same manner as Example 4 for the microporous membrane of each of Examples and Comparative Examples.

Table 6 shows the evaluation results of Example 6.

TABLE 6

| | | | Polyvinylidene fluoride | | Lamellar silicate | | | Shrinkage | |
|---|---|---|---|---|---|---|---|---|---|
| | Base | | | Weight-average | | | Added amount | rate [%] | |
| | material | Ceramics | Material | molecular weight | Material | Dispersibility | [% by weight] | MD | TD |
| Example 6-1 | PE | Alumina | Maleic acid | One million | MEE | Separation type | 10 | 13.0 | 10.7 |
| | | | denatured PVdF | | | | | | |
| Example 6-2 | | | Maleic acid | 280,000 | | | | 10.8 | 8.9 |
| | | | denatured PVdF | | | | | | |
| Example 6-3 | | | PVdF | One million | | | | 15.0 | 13.2 |
| Example 6-4 | | | PVdF | 280,000 | | | | 14.7 | 10.8 |
| Comparative | PE | — | — | — | — | — | — | 67.9 | 61.3 |
| Example 6-1 | | | | | | | | | |
| Comparative | | Alumina | Maleic acid | One million | — | — | — | 19.3 | 17.1 |
| Example 6-2 | | | denatured PVdF | | | | | | |

As shown in Table 6, it was found that the effect is enhanced as the molecular weight of the heat resistant resin included in the surface layer is decreased, and the effect becomes strong when the heat resistant resin having a polar group is used. This is because the interaction with the organic modifier in the clay mineral becomes strong when the heat resistant resin has a polar group, which is considered to be because a few polar groups work effectively in large molecules due to entanglement of the molecules, but the entanglement of the molecules is small, and thus a lot of polar groups work effectively in small molecules.

Thus far, the present disclosure has been described with reference to several embodiments and examples, but the present disclosure is not limited thereto, and can be varied variously within the scope of the gist of the present disclosure. For example, when the microporous membrane is used as a battery separator, the thickness of the microporous membrane and the composition of each material may be set in accordance with the composition of the positive electrode and the negative electrode.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A shrink resistant microporous membrane comprising:
a base material composed of a porous membrane; and
a surface layer that is formed on at least one surface of the base material, and contains a heat resistant resin, a ceramic, and a clay mineral.

2. The shrink resistant microporous membrane according to claim 1,
wherein the clay mineral has a lamellar structure composed by laminating a number of layers.

3. The shrink resistant microporous membrane according to claim 2,
wherein an average particle diameter of the clay mineral dispersed in the surface layer is 1.0 μm or smaller.

4. The shrink resistant microporous membrane according to claim 3,
wherein an aspect ratio of the clay mineral dispersed in the surface layer is 15 or higher.

5. The shrink resistant microporous membrane according to claim 2,
wherein a diffraction intensity with respect to a diffraction angle 2θ of a 001 face of the clay mineral dispersed in the surface layer, which is measured by an X-ray diffraction method, has no characteristic peak.

6. The shrink resistant microporous membrane according to claim 5,
wherein the clay mineral dispersed in the surface layer is separated into a state in which a single layer or 2 to 4 layers are laminated.

7. The shrink resistant microporous membrane according to claim 2,
wherein the clay mineral is lamellar silicate denatured by an organic modifier.

8. The shrink resistant microporous membrane according to claim 7,
wherein the clay mineral has a polar group.

9. The shrink resistant microporous membrane according to claim 8,
wherein the clay mineral has an alkyl chain.

10. The shrink resistant microporous membrane according to claim 9,
wherein the clay mineral is mica fluoride organically modified by bis(2-hydroxyethyl)methyldodecylammonium ions or bentonite organically modified by oleylbis(2-hydroxyethyl)methylammonium.

11. The shrink resistant microporous membrane according to claim 2,
wherein the clay mineral is included at 1% by weight to 10% by weight with respect to a total weight of the heat resistant resin and the clay mineral.

12. The shrink resistant microporous membrane according to claim 2,
wherein the interlayer distance of the clay mineral before dispersion is 0.9 nm to 1.4 nm.

13. The shrink resistant microporous membrane according to claim 1,
wherein the resin material composing the base material is composed of an olefin-based resin.

14. The shrink resistant microporous membrane according to claim 1,
wherein at least one of a melting point and a glass transition temperature of the heat resistant resin is 180° C. or higher.

15. The shrink resistant microporous membrane according to claim 14,
wherein the heat resistant resin is polyvinylidene fluoride.

16. The shrink resistant microporous membrane according to claim 1,
wherein the surface of the ceramic is basic.

17. The shrink resistant microporous membrane according to claim 16,
wherein the ceramic includes at least alumina (Al₂O₃).

18. A battery separator comprising:
a base material composed of a porous membrane; and
a surface layer that is formed on at least one surface of the microporous membrane, and contains a heat resistant resin, a ceramic, and a clay mineral.
